(19) United States
(12) Patent Application Publication
(10) Pub. No.: US 2007/0196267 A1
(43) Pub. Date: Aug. 23, 2007

(54) Hydrogen Generator Apparatus And Start-Up Processes

(76) Inventors: Brandon S. Carpenter, Chicago, IL (US); John R. Harness, Elgin, IL (US); Bradley P. Russell, Wheaton, IL (US)

Correspondence Address: PAULEY PETERSEN & ERICKSON, 2800 W. HIGGINS ROAD, SUITE 365, HOFFMAN ESTATES, IL, 60195, US

(21) Appl. No.: 10/592,551

(22) PCT Filed: Mar. 11, 2005
(86) PCT No.: PCT/US05/08328

§ 371 Date: Sep. 12, 2006

Related U.S. Application Data
(60) Provisional application No. 60/552,996, filed on Mar. 12, 2004.

(51) Int. Cl. C01B 3/02

(52) U.S. Cl. 423/648.1

(57) ABSTRACT

Apparatus and process are provided to enable rapid start up of hydrogen generator (1) that use partial oxidation reforming. In the start up processes, a heated oxygen containing gas (110) is passed through the reformer (106) and at least one downstream unit operation (108) to achieve a first temperature regime. Then a heated steam containing gas is used to raise the temperatures of the reformer (106) and at least one downstream unit operation (108) to a second temperature regime at which partial oxidation reforming can be initiated.

### FIELD OF THE INVENTION

This invention relates to apparatus for the generation of hydrogen and to processes for starting up hydrogen generating apparatus.

### BACKGROUND OF THE INVENTION

Interest exists in using hydrogen as a fuel for motive and stationary power applications, e.g., as a fuel for fuel cells. A readily available source of hydrogen will be required for the use of hydrogen as a fuel to be broadly accepted.

Processes for the generation of hydrogen are well known. Steam reforming of hydrocarbon-containing feedstock is a conventional source of hydrogen. Steam reforming of hydrocarbons is practiced in large-scale processes, often integrated with refinery or chemical operations. Thus, due to their large scale and available skilled labor force, sophisticated unit operations can be used while still economically producing hydrogen.

Hydrogen must be readily available in order to be accepted as an alternative fuel. However, hydrogen is difficult to store and distribute and has low volumetric energy density compared to conventional hydrocarbon fuels such as gasoline. Thus, it is desirable to be able to generate hydrogen for use or distribution at a point proximate to the consumer such that a hydrocarbon-containing feedstock to the hydrogen generator is the material shipped and stored. For example, a hydrocarbon-containing fuel may be provided to a residence or a fueling station and converted at that location to hydrogen for use in a fuel cell or vehicle.

Much greater challenges exist in producing hydrogen in smaller scale units than for the large industrial-scale hydrogen generators. The severity of this challenge is increased where, due to fluctuating demand for hydrogen, the hydrogen generator may need to be shut down and restarted frequently. To avoid undue on-site storage of hydrogen or to reduce the size and cost of energy storage devices such as batteries, the start-up procedures must be rapid. Moreover, for smaller scale hydrogen generators to be commercially acceptable they must be simple to operate (preferably highly automated), reliable, and low in cost. Hence, the hydrogen generator must meet performance as well as economic targets.

One of the difficulties in providing a hydrogen generator that may face varying production demands involves enabling the hydrogen generator to be quickly started when a demand for hydrogen production exists. A number of objectives need to be met. For instance, the start up process for a hydrogen generator should not only be rapid, but also it should not deleteriously affect the materials of construction or catalysts used within the hydrogen generator. Additionally, stable operation of the hydrogen generator needs to be achieved prior to exporting hydrogen product to reduce the potential of upsets that adversely affect downstream users of the hydrogen product. Typically stable operation is achieved when each of the unit operations of the hydrogen generator are at or near their respective steady-state conditions. For instance, stable operation of the hydrogen generator may not be achieved when the reformer is at or near steady-state conditions but the carbon monoxide reduction operations such as water gas shift or selective oxidation, are not at or near-steady state conditions.

Unfortunately, designs that favor desirable economics of operation may adversely affect the ability to achieve sought start up performance. By way of example, the heat integration required to provide energy efficient hydrogen generators can work against the objectives for rapid start up. For example, since reforming occurs at elevated temperatures, often well in excess of 600° C., heat exchangers are used to cool the reformate for further processing, such as water gas shift and selective oxidation. As the start-up procedure requires that the catalysts in the various reactors reach temperatures suitable for initiating the respective reactions, heat losses and added thermal mass imposed by the intervening equipment increase the difficulty of rapidly achieving the required catalyst operating temperatures. Additionally, the materials of construction and potential for catalyst deactivation pose practical limits as to the type of start up procedure used.

An additional problem in starting up a hydrogen generator is that the generator contains a number of unit operations beyond the reforming operation and many of these operations will need to be raised to suitable temperatures for commencement of the intended function. Thus, if a water gas shift operation is employed, the catalyst for the shift will need to be brought to a temperature where the sought reaction can be initiated. The temperatures of unit operations other than catalytic reactors may also need to be suitably raised before a hydrogen product of acceptable quality is produced. For instance, heat exchangers typically used to recover heat from, and thus reduce the temperature of, the reformats may rely in part upon vaporization of water to achieve the necessary cooling. If start up occurs without the heat exchanger functioning as intended, e.g., due to a lack of water flow on the cold side, reformate might not be adequately cooled and damage to downstream operations and process instability or upsets, including a loss of hydrogen product quality, could occur.

One proposed start-up strategy involves directing a heated gas to the reformer and this gas is then sequentially passed to downstream unit operations. See, for instance, U.S. Pat. No. 6,521,204. However, with the heat absorbed in the reformer as well as heat losses to the environment, practical difficulties can exist in using this sequential approach for rapid heating of downstream units to temperatures desired to commence operation. For instance, there is a practical limit on the temperature of the gas used to heat the reformer. If the temperature is too high, risk of damage to catalysts and materials of construction exist. Alternatively, lower temperature gas can be used, but the flow rate of the gas must be increased, which may involve added compression capacity and costs, to provide the same amount of heat.

A number of proposals have been made for the start up of hydrogen generators in an attempt to minimize one or more of the aforementioned problems. US 2003/0093950 discloses the use of two burners to produce combustion gases for start up of a hydrogen generator. The effluent from one burner is used to heat the reformer, and the effluent from the other is used to heat a water gas shift reactor/heat exchanger and preferential oxidation unit.

An earlier patent having a common inventor, U.S. Pat. No. 6,521,204, had proposed combusting a fuel in a reformer, and then passing the combustion effluent from the exit of the reformer to downstream unit operations. The disclosed process involves first passing a lean fuel and air mixture to the reactor for a lean combustion. Considerable excess air is used to keep the temperatures of the hot gases below a level that would degrade the ceramic and/or catalytic materials. In commencing the lean burn, the patentees state that preferably an air flow is supplied and then fuel is added. Steam is then used to purge excess air from the system before a fuel rich mixture is supplied to commence reforming. While the start up process involving the steam purge is stated to reduce the formation of carbon, it is apparent that combustion within the reformer poses risks to the materials of construction and catalysts. Maintaining a stable combustion can be difficult and an excursion could lead to undesirably high temperatures. The variety of fuels capable of being used can be problematic as practical constraints favor those fuels having lower ignition temperatures such as methanol. For combustion of lighter fuels such as natural gas or propane, a flame burner is generally required for stable combustion. The addition of a flame burner adds complexity and cost to the reformer design.

US 2003/0019156 in paragraph 43 discusses problems with conventional methods for starting up reformers. The application states that an inert gas heated by a heat source such as an electric heater is passed into the fuel feed line. A large amount of inert gas is required since subsequent catalyst layers are not heated until the first catalyst layer is heated. Thus a long time period is required for the reformer to reach the required temperature. This published patent application only relates to heating a reformer, and the problems noted would be exacerbated when downstream unit operations also need to be heated. The process disclosed in the application involves passing a heated air stream to reforming catalyst to oxidize the catalyst thereby generating additional heat.

Another start up method is disclosed in US 2003/0170510. The application notes that conventional fuel processing systems are started up using a cascading technique. In this technique, it is stated that the reformer pulls most of the heat of combustion out of the stream passing through it until it reaches operating temperature. During that period little additional heat is available to raise the temperature of the downstream components. The application further notes that the amount of fuel that can be burned in the reformer is limited by the size of the combustor. The application states that without utilizing an oversized combustor, the heating of the fuel processor cannot exceed approximately 20% of full power. To avoid this problem during start up, the application discloses using a fuel rich oxidation throughout the fuel processing system and injecting air into downstream components of the system such that combustion occurs within downstream components for heating in parallel. This approach to start up is also disclosed in U.S. Pat. No. 6,524,550.

In one of the alternative embodiments disclosed in U.S. Pat. No. 6,635,372, a fuel and air mixture is directed to a fuel processor. The patentees state that water may also be added to the fuel processor during start up. See Column 6, lines 5 to 8.

A need exists for hydrogen generators that can be rapidly started up using an automated, highly reliable procedure and do not require undue cost such as in significant additional unit operation equipment used solely for start-up or costly materials of construction, and do not pose a significant risk of damage to the catalysts.

### SUMMARY OF THE INVENTION

In accordance with this invention, hydrogen generators for the partial oxidation reforming of fuels and processes for the start-up of hydrogen generators are provided. In the processes of the invention, a heated oxygen-containing stream is used at start up to raise the temperature of a partial oxidation reformer and at least one downstream unit operation to enable a steam-containing gas to be used to further increase the temperatures in the hydrogen generator.

In broad aspects, the processes for starting up a hydrogen generator, which generator comprises a partial oxidation reformer containing partial oxidation and steam reforming catalyst adapted to provide a hydrogen-containing reformate and at least one downstream unit operation adapted to treat the reformate, comprise:
a. passing heated oxygen-containing gas, preferably heated by indirect heat exchange, sequentially through the partial oxidation reformer and at least one downstream unit operation to heat the partial oxidation reformer and at least one downstream unit operation to a first temperature regime, said first temperature regime being a temperature in each of the partial oxidation reformer and the at least one downstream unit operation above that which water condenses from a steam-containing stream of step (b) therein, wherein the temperature of the heated oxygen-containing stream is sufficient to effect such heating but below that which can unduly deleteriously affect catalyst in the partial oxidation reformer,
b. then passing a heated steam-containing gas, preferably containing at least about 10, more preferably at least about 20, volume percent steam, sequentially through the partial oxidation reformer and the at least one downstream unit operation until a second temperature regime hotter than the first temperature regime is achieved, said second temperature regime comprising a temperature in the partial oxidation reformer sufficient to initiate partial oxidation reforming and, in preferred aspects, the second temperature regime comprises a temperature in the at least one downstream unit operation sufficient to initiate the intended unit operation, said steam-containing gas having a temperature sufficient to effect such heating but below that which can unduly deleteriously affect catalyst in the partial oxidation reformer, and
c. thereafter passing a fuel, oxygen-containing gas and water to the reformer in amounts sufficient for reforming whereby initiation of the partial oxidation reforming occurs and a hydrogen containing reformate is produced.

In a preferred aspect of the invention, the first temperature regime comprises a temperature in the partial oxidation reformer insufficient to initiate partial oxidation reforming. In another preferred aspect, a catalytic combustor is provided between the partial oxidation reformer and a downstream unit operation to provide supplemental heat for the start up. In this aspect of the invention, an oxygen-containing gas is injected into the catalytic combustor whereby hydrogen in the reformate is combusted in order to provide heat to the downstream unit operation for a time sufficient to heat the downstream unit operation to a temperature sufficient to complete start up of such unit.

The processes of this invention thus permit start-up without risk of catalyst damage due to condensing water on catalyst or coking due to introduction of hydrocarbon feed at elevated temperatures without sufficient steam. The specific heat capacity of steam is higher than, for example, air, so that more heat can be transferred to the hydrogen generator per unit amount of the heating gas. Further, steam can be generated by vaporizing liquid water in a compressed gas stream. The thus generated steam will not require gas compression thus enabling a saving on the gas compressor capital and operating costs required to provide a heating gas for start-up. Not only will an opportunity for savings in compression costs be realized, but also the partial oxidation reformer need not be subjected to as high a temperature at a given heating gas flow rate, to heat downstream unit operations to given temperatures.

In preferred embodiments of this invention where the gases to heat the hydrogen generator are heated by indirect heat exchange with a combustion effluent, the vaporization of liquid water in the heat exchanger can enable more efficient heat recovery from the combustion gases. One advantageous aspect of the invention is that a heat exchanger intended to heat a feed stream to a desired temperature for introduction into the reformer during normal operation may be useful as an indirect heat exchanger for the gases supplied to the reformer during start up.

Advantageously, once the second temperature regime has been achieved, any oxygen remaining in the hydrogen generator is purged prior to initiating the supply of fuel, water and oxygen-containing gas to the reformer. Purging is conveniently effected by passing steam having an essential absence of free oxygen through the reformer and the downstream unit operations.

The hydrogen generators of this invention comprise:
a. a partial oxidation reformer containing partial oxidation and steam reforming catalyst and having an inlet and an outlet,
b. at least one downstream unit operation having an inlet and an outlet wherein the inlet is in fluid communication with the outlet of the partial oxidation reformer,
c. an oxygen-containing gas supply line in fluid communication with the inlet of the reformer, said oxygen-containing gas supply line having a valve capable of shutting off the flow of oxygen-containing gas,
d. a combustor being in fluid communication with a fuel supply line,
e. a heat exchanger having a hot side and a cold side with the hot side in fluid communication with the combustor and the cold side in fluid communication with the oxygen-containing gas supply line,
f. a liquid water supply line in fluid communication with the oxygen-containing gas supply line and heat exchanger, said water supply line having a valve capable of shutting off the flow of water,
g. a fuel supply line in fluid communication with the inlet of the reformer, said fuel supply line having a valve capable of shutting off the flow of fuel,
h. at least one temperature sensor adapted to detect temperature between the inlet of the partial oxidation reformer and the outlet of the at least one downstream unit operation, and
i. a controller in communication with at least one of said temperature sensors, said controller being adapted to open or close the valve for the oxygen-containing gas supply line in response to a temperature detected by at least one of said temperature sensors, to open or close the valve for the water supply line in response to a temperature detected by at least one of said temperature sensors, and to open or close the valve for the fuel supply line in response to a temperature detected by at least on of said temperature sensors.

### BRIEF DESCRIPTION OF THE DRAWINGS

FIG. 1 is a schematic diagram of an apparatus in accordance with this invention wherein the oxygen-containing gas is heated by combustion with fuel and the combustion gases are used for heating during start up and combustion gas effluent is used to heat a selective oxidation reactor.

FIG. 2 is a schematic diagram of an apparatus in accordance with this invention wherein the oxygen-containing gas is heated by indirect heat exchange with combustion effluent for start up.

FIG. 3 is a schematic depiction of a dual-mode (flame plus catalytic) burner design capable of handling a wide range of flows and fuels.

### DETAILED DESCRIPTION OF THE INVENTION

Overview of Hydrogen Generation Processes

The hydrocarbon-containing feeds used for reforming are typically gaseous under the conditions of reforming. Lower hydrocarbon gases such as methane, ethane, propane, butane and the like may be used. Because of availability, natural gas and liquid petroleum gas (LPG) are most often used as feeds. Biogas may also be used as a feed. Oxygenated fuels such as methanol and ethanol are included as hydrocarbon-containing feeds for all purposes herein.

Natural gas and LPG typically contain sulfur compounds, including odorants that are intentionally added for leak detection. Odorants conventionally used are one or more organosulfur compounds such as organosulfides, e.g., dimethyl sulfide, diethyl sulfide, and methyl ethyl sulfide; mercaptans, e.g., methyl mercaptan, ethyl mercaptan, and t-butyl mercaptan; thiophenes of which tetrahydrothiophene is the most common; and the like. The amount used can vary widely. For natural gas, the organosulfur component is often in the range of about 1 to 20 parts per million by volume (ppmv); and for LPG a greater amount of sulfur compounds are typically used, e.g., from about 10 to 200 ppmv. It is not unusual for commercially obtained hydrocarbon feeds to contain also other sulfur compounds which may be natural impurities such as hydrogen sulfide and carbonyl sulfide. Hydrogen sulfide and carbonyl sulfide concentrations in natural gas and LPG of 0.1 to 5 ppmv are not unusual. Regardless of the form of the sulfur, it can be deleterious to catalysts used in hydrogen generators and to fuel cells. Accordingly, the feed should be desulfurized. Any convenient desulfurization technique may be used including sorption and hydrodesulfurization.

Because of the difficulty in removing thiophenes, an aspect of the invention pertaining to sulfur compound removal involves contacting a fluid containing organosulfur compounds including thiophenes with a solid sorbent selective for thiophene sorption as compared to at least one other organosulfur compound to sorb thiophenes while allowing the at least one other organosulfur compound to break through. Examples of suitable sorbents include molecular sieves and molecular sieves that have been ion exchanged with one or more transition metals, such as Ag, Cu, Ni, Zn, Fe and Co. Molecular sieves include the X-type, A-type, Y-type, and beta-type zeolites. The most preferred molecular sieves are the X-type, especially 13X exchanged with zinc. Satokawa, et al., disclose in US 2001/0014304 zeolite sorbents for removal of sulfur compounds at lower temperatures. Thus, in accordance with this aspect of the invention, the sorbent need only be sized to effect removal of thiophenes, not the total organosulfur compound content of the fluid. The organosulfur compounds that break through can, if desired, be removed in any suitable manner such as hydrodesulfurization, sorption, and the like.

The feeds can contain other impurities such as carbon dioxide, nitrogen and water. Preferably, the concentration of carbon dioxide is less than about 5, more preferably less than about 2, volume percent.

Water in addition to that contained in the other feed components (e.g., hydrocarbon and air) to the process may be required. This additional water preferably is deionized. The source of the oxygen-containing raw material may be pure oxygen, oxygen-enriched air, or most conveniently, air. When enriched, the air frequently contains at least about 25, often at least about 30, volume percent oxygen. The nitrogen and oxygen-containing gas useful in this invention preferably contains at least about 20 volume percent nitrogen and is frequently air or oxygen-enriched air.

Hydrogen generating processes are known and may use a variety of unit operations and types of unit operations. For instance, at least one, if not all, the feed components to the reformer are typically heated prior to being passed to the reformer. This heating of one or more feed components, i.e., oxygen-containing gas, fuel, and steam, is often accomplished by heat recovery from combustion effluent and by heat recovery from reformate as it passes to various unit operations within the hydrogen generator. In some instances, the heating of one or more of the components to be introduced into the reformer is accomplished by indirect heat exchange with combustion gases. Different types of heat-integration schemes may be used within the process, and the reactant streams may be heated individually or often after admixing.

Partial oxidation reforming conditions typically comprise a temperature of from about 600° C. to about 1000° C., preferably about 600° C. to 800° C. and a pressure of from about 1 to about 25 bar absolute (100 to 2500 kPa). The partial oxidation reforming is catalytic. The overall partial oxidation and steam reforming reactions for methane are expressed by the formulae:
CH₄+0.5 O₂→CO+2H₂
CH₄+H₂O [symbol] CO+3H₂

The reformer may comprise two discrete sections, e.g., a first contact layer of oxidation catalyst followed by a second layer of steam reforming catalyst, or may be bifunctional, i.e., oxidation catalyst and steam reforming catalyst are intermixed in a single catalyst bed or are placed on a common support. The partial oxidation reformate comprises hydrogen, nitrogen (if air is used as the source of oxygen), carbon oxides (carbon monoxide and carbon dioxide), steam and some unconverted hydrocarbons.

Typically, the feed to the partial oxidation reformer comprises an oxygen (molecular) to carbon ratio (O₂/C) of between about 0.3:1 to 0.7:1, preferably 0.4:1 to 0.6:1 and a steam to carbon (S/C) of between about 1:1 to 8:1, preferably 2:1 to 6:1.

The reformate, reforming effluent, is a gas and is preferably subjected to one or more carbon monoxide reducing unit operations. A water gas shift is most typically used. Generally, the shift reactor contains at least one water gas shift reaction zone. The reformate is typically at temperatures in excess of about 600° C. as it exits the reformer. The reformate contains hydrogen, carbon dioxide and carbon monoxide as well as water and nitrogen if air is used as the oxygen-containing gas for the partial oxidation reforming. On a dry basis, the components of the effluent for the reformer fall within the ranges set forth below when air is used as the oxygen-containing gas:

REFORMER EFFLUENT COMPONENTS,
MOLE PERCENT DRY BASIS

| Component | Autothermal Reforming |
|---|---|
| Hydrogen | 35 to 55, frequently 40 to 45 |
| Nitrogen | 25 to 45, frequently 30 to 35 |
| Carbon monoxide | 2 to 10, frequently 5 to 8 |
| Carbon dioxide | 10 to 20, frequently, 12 to 15 |

The reformate is cooled, and if desired, passed to a shift reactor operating under water gas shift conditions. In the shift reactor, carbon monoxide is exothermically reacted in the presence of a shift catalyst with an excess amount of steam to produce additional amounts of carbon dioxide and hydrogen. The shift reaction is an equilibrium reaction. The reformate thus has a reduced carbon monoxide content. Any number of water gas shift reaction zones may be employed to reduce the carbon monoxide level in the hydrogen product stream, with each stage being at a lower temperature since the equilibrium favors reduced carbon monoxide concentration at lower temperatures.

In the broader aspects of the invention, other carbon monoxide reducing unit operations and hydrogen purification operations may be used together with or as an alternative to water gas shift. These unit operations include, by way of example and not in limitation, selective permeation through membranes, low temperature water-gas shift followed by selective oxidation to preferentially oxidize carbon monoxide to carbon dioxide without undue combustion of hydrogen, and the use of pressure or thermal swing adsorption. If pressure swing adsorption is used, the reformate should typically be provided at an elevated pressure and suitable temperatures, usually below about 90° C. Usually pressures in the range of about 5 to 15 bar absolute (500 to 1500 kPa) and temperatures less than about 60° C., often in the range of 20° to 50° C., are desired. The reforming may occur at suitable pressures for pressure swing adsorption or the reformate may be compressed to a suitable pressure at any point prior to the pressure swing adsorption.

Start Up Processes

As stated above, the processes of this invention involve the use of sequentially at least two different gaseous heating media. First, a heated oxygen-containing gas is used as the heating medium for the reformer and at least one downstream unit operation until the reformer and downstream unit operation have achieved a first temperature regime. The first temperature regime involves bringing the reformer and such at least one downstream unit operation to a temperature where steam can be present without condensation of water. The temperature at which steam can condense can be determined through the calculation of the dew point at the conditions of the hydrogen generator and composition of the heating medium. In preferred embodiments of the invention, the first temperature regime is insufficient to initiate operation of the hydrogen generator. Then a heated steam-containing gas is used as the heating medium to achieve a second temperature regime which is a hotter temperature regime. The term hotter temperature regime is intended to mean that the temperature in at least one of the reformer and downstream unit operations is increased. The second temperature regime comprises a reformer temperature sufficient to initiate partial oxidation reforming and the at least one downstream unit operation being at a temperature suitable to effect the intended unit operation, and thus the second temperature regime can enable the operation of the hydrogen generator to be commenced.

In accordance with the broad aspects of the invention, it is not essential that the reformer and the at least one downstream unit be at temperatures anticipated for normal steady state operation. Rather, the temperatures are sufficient to enable initiation of operation. For instance, the reformer may need only be at a temperature where partial oxidation can be initiated, and the heat from the partial oxidation may serve to increase the temperature of the reformer to within the normal operating regime. Similarly, the at least one downstream unit operation need only be at a temperature such that when contacted with the hot reformate, initiation of the unit operation occurs.

Downstream unit operations broadly encompass heat exchangers as well as catalytic reactors such as shift reactors and selective oxidation reactors. Especially for heat exchangers that take advantage of the boiling of water during normal operation, achieving a suitable elevated temperature can be essential during start up to assure that the heat exchanger functions correctly when the generation of hydrogen is commenced and to avoid unstable or upset conditions. In many instances, the at least one downstream unit operation will comprise one or more shift reactors.

The oxygen-containing gas used for pre-heating the reformer and downstream reactor(s) may be the same or different than that used for the reforming. The oxygen-containing gas often contains between about 5 and 30 volume percent free oxygen. Air is a particularly attractive oxygen-containing gas due to its ready availability.

The process steps used at the beginning of the start up process will depend upon the condition of the hydrogen generator at the time of shut down. For instance, the generator may have been purged with nitrogen or steam when shut down and these gases will be swept from the system with the addition of the oxygen-containing gas. However, if the system contains combustibles such as hydrogen-containing reformate or fuel, conditions that could result in an uncontrolled combustion upon addition of the oxygen-containing gas should be avoided. Thus, the system could be purged with an inert gas such as nitrogen prior to introducing the oxygen-containing gas.

The oxygen-containing gas used to achieve the first temperature regime may be heated by indirect heat exchange, say, with a combustion exhaust gas, or by combustion of an oxygen-containing gas with a fuel, preferably under fuel lean conditions. Diluents such as nitrogen or air may be added to the combustion effluent to reduce temperature. In the preferred aspects of the invention, the oxygen-containing gas is heated by indirect heat exchange with a combustion gas effluent. The indirect heat exchange permits greater stability and a better control of the temperature of the oxygen-containing gas, especially where using fuels such as methane that are not conducive to stable catalytic oxidation. Often the same heat exchanger and combustor may be used to heat the oxygen-containing gas as is used to heat the oxygen-containing feed for the partial oxidation reforming. The combustor may, for instance, be the combustor used to combust waste gases from the hydrogen generator (e.g., a waste gas stream from an adsorber used to purify the hydrogen product) or anode effluent from a fuel cell. As can be appreciated, open flame combustion of, say, methane, can be readily accommodated for a heat source for an indirect heat exchange since any variations in temperature and volume of combustion effluent are attenuated in the indirect heat exchange process.

The heating of the oxygen-containing stream is generally to a temperature of between about 300° C. and 800° C. Preferably the temperatures are below about 700° C. such that the use of expensive materials of construction is not generally necessary and the risk of damage to the catalysts used for the partial oxidation reforming and any catalyst used in a downstream unit operation is very low. Most often, the temperatures are within the range of about 350° or 400° C. to 650° C. Usually the temperature of the oxygen-containing gas provided to the hydrogen generator is increased over a period of time to avoid undue thermal stresses that could be caused by rapid heating. The time to reach the final oxygen-containing gas temperature level at start up will depend upon the type and specific design of the means to heat the oxygen-containing gas and its size. The pressure of the heated oxygen-containing gas used to achieve the first temperature regime is not critical to the broad aspects of the invention. In general, the pressure is above ambient pressure. Higher pressures do increase the heat capacity of the gas per unit volume; however, capital and operating costs for compression can be practical considerations. Advantageously, the pressure of the oxygen-containing gas is approximately that used for normal operation of the hydrogen generator and, as stated above, the compression equipment is sized for the normal operation, not the start-up requirements.

The duration of this step in the start up process can vary widely depending upon the size of the hydrogen generator, the ratio of the thermal mass of the hydrogen generator to the volume of oxygen-containing gas, the sensitivity of the hydrogen generator to thermal stresses, the temperature regime desired to be obtained and the like. It is generally desirable to pre-heat the apparatus as quickly as possible. Often, this step is effected in less than about 30 minutes.

The flowrate of the oxygen-containing stream may fall within a wide range, e.g., at least about 1000 hr⁻¹, say, from about 3,000 to 30,000 hr⁻¹, gas hourly space velocity (GHSV) at standard temperature and pressure (STP) based upon the volume of catalyst in the partial oxidation reformer. At higher flow rates, more heat can be distributed in the hydrogen generator during a given time interval than at lower flow rates. However, practical limits exist as to the flow rate. Compressor or blower capacities suitable to provide oxygen-containing gas for normal operation of the hydrogen generator may not be sufficient to provide as much oxygen containing gas as might be desired during start up. As discussed in more detail later, the processes of this invention can accommodate such under sized compressors or blowers through introducing liquid water which vaporizes to provide flow rates greater than those achievable with the oxygen-containing gas alone.

Accordingly, the oxygen-containing gas is used to increase the temperatures of the reformer and at least one downstream unit operation to a point where a steam-containing gas can be used as the heating medium without risk of condensation in the reformer or downstream unit operations. Liquid water can adversely affect some catalysts and may have other deleterious effects in the hydrogen generator. Thus, the oxygen-containing gas is used to increase the temperatures of the partial oxidation reformer and at least one downstream unit operation to within a first temperature regime.

The term “first temperature regime” is intended to connote that the reformer and downstream unit operation have reached at least a temperature where the amount of steam to be introduced into the oxygen-containing gas will not condense within the reformer or the at least one downstream unit operation. Typically, the at least one downstream unit operation is one that can be adversely affected by liquid water, e.g., a water gas shift unit operation or a selective oxidation unit operation. Other downstream unit operations may exist where condensation of water is not adverse, such as condensers and such downstream unit operations may not be used as the at least one downstream unit for purposes of this invention. The first temperature regime may be at or far in excess of the minimum temperature required to prevent condensation. The specific minimum temperature will, of course, be dependent upon the composition of the steam-containing gas and the pressure in the hydrogen generator. Also, with the cooling of the oxygen-containing gas as it sequentially passes through the reformer and the downstream unit operation, the last unit operation of the at least one downstream unit operation will be at a lower temperature than the reformer. For the purposes of determining the minimum temperature of the first temperature regime, the dew point temperature of the oxygen-containing gas and steam admixture intended to be introduced to complete the heating can be calculated for the conditions, e.g., pressure and steam concentration, in the hydrogen generator. Often the first temperature regime comprises a temperature in the effluent from the partial oxidation reformer of less than about 350° C., frequently less than about 250° C., and a temperature in the effluent from the final downstream unit operation in the sequence of at least about 50° C., and frequently less than about 200° C., say, less than about 150° C.

It is not required by this invention that a minimum temperature for the first temperature regime be calculated. The operator or automatic controller may simply select a temperature that clearly poses no risk for condensation within the at least one downstream unit operation for purposes herein. Moreover, the operator or automatic controller need not measure the temperature. Rather, for example, experience with start up of a particular hydrogen generator may be sufficient to determine by the passage of time when water can be safely added to the oxygen-containing gas. Thus the operator or automatic controller has great latitude in not only determining when to initiate adding water to the oxygen-containing gas but also in selecting how to monitor the start up for determining when to commence using the steam-containing gas as the heating medium.

Once the sought heating is accomplished by the oxygen-containing gas, a heated steam-containing gas is used to continue the start up process. In broad aspects of this invention, the heated steam-containing gas may be obtained in any convenient manner. As smaller scale hydrogen generators are often located in the field and thus may not have a heated steam source, generation of the steam by the hydrogen generator during start up is generally necessary. The steam-containing stream may contain an oxygen-containing gas or may have an essential absence of free oxygen. The steam-containing stream often contains at least about 10, preferably at least about 20 or 25, and sometimes from about 25 to 100, volume percent water. Other components such as oxygen and nitrogen may be present. For instance, oxygen would be present when the steam-containing stream is generated by introduction of water into the oxygen-containing gas.

In an embodiment of this invention, the heated steam-containing stream may be a combined stream of steam and a combustion gas. The combustion gas comprises the product of combustion of fuel with oxygen-containing gas. The combustion may be effected by catalyst or by flame. With fuels such as methane and LPG, effecting stable catalytic oxidation is difficult, hence the ability to use a flame combustion is beneficial. For the combustion by a flame, the fuel and oxygen-containing gas should be provided within flammability limits. In such instances, the amount of steam provided in the combustion effluent is such that the effluent is less than about 800° C., preferably less than about 700° C. Often, the volume ratio of steam to combustion gas is at least about 1:5, say, 1:4 to 4:1. The steam can provide a moderating effect and not only serve to reduce the temperature of the combustion gas but also attenuate any instability in combustion gas production rate or temperature to minimize the risk of damage to catalysts or materials of construction of the hydrogen generator.

In one particularly attractive mode of practicing the invention, heated oxygen-containing gas is continued to be supplied to the partial oxidation reformer and steam is introduced into the oxygen-containing stream. Advantageously, the steam is generated by injecting liquid water into the oxygen-containing gas and vaporizing the water to not only increase the flow rate of gas to the partial oxidation reformer and carry additional heat but also to minimize compression capacity. For instance, where the oxygen-containing gas is heated by indirect heat exchange, e.g., with combustion gases, the heat exchanger surface may also serve to vaporize the water. Due to the liquid contact and vaporization, the efficiency of the heat exchanger can be increased. Additionally, steam has a higher heat capacity than air, and thus there can be an enhancement in the ability of the steam-containing gas to heat the partial oxidation reformer and the at least one downstream unit operation.

The amount of water added to the oxygen-containing gas may vary during the duration of this step in the start up process. The presence of the oxygen-containing gas reduces the partial pressure of the steam and thus decreases the dew point temperature. Hence, in some instances, it may be desirable to add a small amount of water to the oxygen-containing gas at the initiation of this step of the start up process to avoid condensation in the hydrogen generator until the temperature therein has further increased. Then, the amount of water added can be increased incrementally or continuously, again at a rate avoiding the risk of condensation in the reformer and downstream unit operation. Since it is often preferred to purge the reformer and downstream unit operations of oxygen prior to introducing fuel, the incremental increases in water addition can be accompanied by a decrease in the amount of oxygen-containing gas added until substantially pure steam is passed through the reactors for purging.

The heated steam-containing stream is generally provided at a temperature of between about 300° C. to 800° C., preferably between about 350° C. or 400° C. and 700° C. The pressure of the heated steam-containing stream used to achieve the second temperature regime is not critical to the broad aspects of the invention. In general, the pressure is above ambient pressure. Higher pressures do increase the heat capacity of the gas per unit volume; however, capital and operating costs for compression can be practical considerations. Advantageously, the pressure of the steam-containing gas is approximately that used for normal operation of the hydrogen generator and, as stated above, the compression equipment is sized for the normal operation, not the start-up requirements. The duration of the step of supplying a steam-containing gas for start up can vary widely depending upon the volume of the hydrogen generator relative to the flow rate of the steam-containing gas, the ratio of the thermal mass of the hydrogen generator to the volume of steam-containing gas, and the like. Preferably the step is effected as rapidly as possible, and often in less than about 30 minutes.

The term “second temperature regime” is intended to connote that the reformer and the at least one downstream unit operation have reached at least a temperature where the partial oxidation reforming and the intended unit operation in the at least one downstream unit operation can be initiated. Most importantly, the partial oxidation reforming catalyst must be at a temperature high enough to initiate the partial oxidation reaction, that is, above the light-off temperature. The temperature may be at or above the minimum temperatures for the second temperature regime. Identification of the second temperature regime can be readily determined by one of ordinary skill in catalytic reactions upon selection of the catalyst and reaction to be undertaken. Often the second temperature regime comprises a temperature at the partial oxidation reformer outlet of at least about 250° C., preferably, 250° C. to 500° C. If the downstream unit operation is a water gas shift reactor, the temperature at its outlet is preferably at least about 100° C., and most frequently between about 150° C. and 300° C. If a downstream unit operation is a selective oxidation reactor, the second temperature regime generally includes a temperature at the outlet of the selective oxidation reactor of at least about 50° C., and sometimes between about 75° C. and 150° C.

The temperature ranges given above in the second temperature regime are generally below the normal operating temperatures of the respective reactors. It is most important, however, that the partial oxidation reforming catalyst be above the light-off temperature for the respective hydrocarbon fuel prior to transitioning to fuel-rich reforming.

As is readily apparent, the minimum second temperature regime will be dependent upon the nature of the catalyst in the partial oxidation reformer and the unit operation to be conducted in the at least one downstream unit operation. The operator or automatic controller need not measure the temperature to determine whether the temperature is in the second temperature regime. Rather, for example, experience with start up of a particular hydrogen generator may be sufficient to determine by the passage of time when the reforming process can be initiated. Thus the operator or automatic controller has great latitude in not only determining when to start the reforming process but also in selecting how to monitor the start up for determining when to start the reforming process.

The flow rate of the steam-containing gas may be within a wide range, e.g., at least about 1000 hr⁻¹, say, from about 3,000 to 30,000 hr⁻¹, GHSV at STP based upon the volume of catalyst in the partial oxidation reformer. The flow rate is often greater than that in the prior step using an oxygen-containing gas, e.g., at least 10, say, up to 300, e.g., 20 to 300, percent greater as vaporization of water can increase volume without additional gas compression capacity.

When the partial oxidation reformer and downstream reactor(s) have achieved the second temperature regime, hydrocarbon fuel, steam, and oxygen-containing gas are introduced in order to begin fuel-rich reforming. However, prior to this transition it is desirable to introduce steam into the apparatus such that coking of the hydrocarbon fuel on the hot catalyst and within hot equipment is prevented.

Usually, the hydrogen generator is purged with steam having an essential absence of free oxygen prior to commencing the reforming reaction, especially where the oxygen-containing gas and steam stream contains a significant amount of free oxygen. Typically, the steam used for the purging is at a temperature such that undue cooling of the reformer and downstream reactors does not occur, i.e., within about 50° C. of the temperature of the gas stream using in the preceding step. The purge may be relatively short in duration, e.g., sufficient to pass through the hydrogen generator about 1 to 10 volumes of steam (at the conditions in the hydrogen generator) per volume of the hydrogen generator.

After purging is complete, reforming is initiated by feeding fuel, oxygen-containing gas and steam to the partial oxidation reformer. The oxygen-to-fuel ratio is controlled so that the desired operating temperature at the reformer outlet is achieved. Temperatures in downstream units such as heat exchangers and reactors may continue to increase after the transition to reforming. The start-up process is completed when all of the downstream units have reached a sufficient temperature such that the composition of the product hydrogen stream is within specifications.

Optionally, one or more downstream unit operations may be separately heated or supplementally heated, that is, the heated steam-containing gas may not be the sole source of heat to increase the temperature of a downstream unit operation to that sought during start up. For instance, upon the initiation of the partial oxidation reforming, an oxygen-containing gas may be injected into a downstream catalytic reactor for combustion with hydrogen to provide additional heating of at least one downstream unit operation to desired temperatures.

### DETAILED DESCRIPTION OF THE DRAWINGS

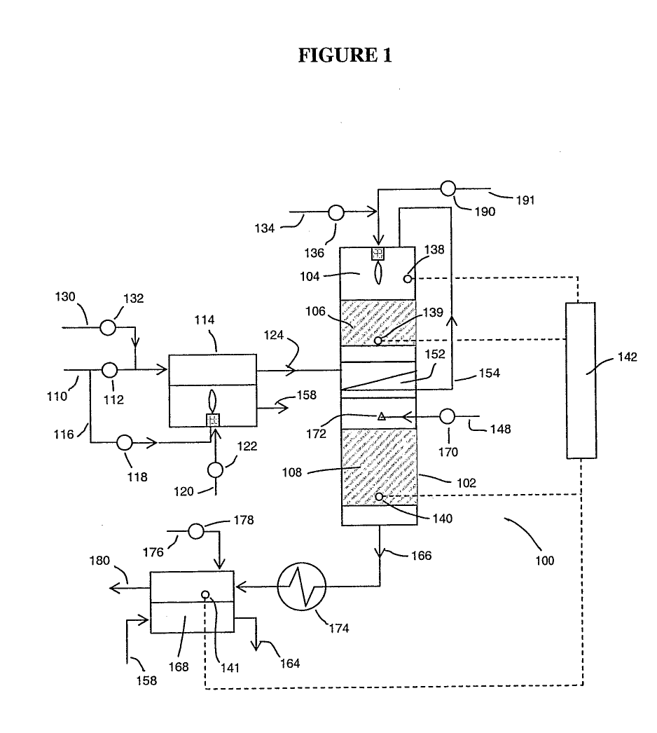

With reference to FIG. 1, the hydrogen generator 100 comprises a cylindrical tower 102 having therein several catalyst stages. At the top is a flame combustor 104, which is in fluid communication with autothermal reformer stage 106, and at the bottom is a water gas shift stage 108.

At start up, oxygen-containing gas, which for the purposes of this Figure shall be air, is provided via line 110. A portion of the air is metered through valve 112 and passed to heat exchanger 114. Another portion of the air is passed via line 116 at a rate established by valve 118 to a combustion side of heat exchanger 114. The combustion side of heat exchanger 114 effects a flame combustion of fuel supplied from line 120. The amount of fuel supplied is regulated by valve 122.

The heat from the combustion serves by indirect heat exchange to increase the temperature of the air. The heated air during start up is directed via line 124 to heat exchanger 152 positioned in tower 102 between reformer stage 106 and water gas shift stage 108. From heat exchanger 152 air is directed via line 154 to the top of tower 102.

The temperature in tower 102 is monitored prior to the reformer stage 106, within the partial oxidation reforming catalyst 106, within the water gas shift stage 108, and in selective oxidation reactor 168 via thermocouples 138, 139, 140, and 141, respectively. The temperatures are transmitted to controller 142. Once the partial oxidation catalyst 106, water gas shift stage 108 and selective oxidation reactor 168 achieve the desired first temperature regime, controller 142 opens valve 132 to provide liquid water via line 130. The water is admixed with the air passing to heat exchanger 114. The water is vaporized in heat exchanger 114 and passed with the air through heat exchanger 152 to the top of tower 102. As shown, additional fuel (e.g., methane) can be added via line 134 at a rate set by valve 136 for admixture with air provided in line 191. This admixture is combusted in flame burner 104 to provide additional heat to tower 102 and especially to reformer stage 106. This additional combustion in burner 104 may occur before or after the addition of water in line 130, but preferably prior to such addition. Controller 142, in response to the temperature detected by thermocouple 138, adjusts the flow of fuel by means of valve 136 and adjusts the flow of air by valve 190 in order to maintain the temperature of the gases passing through tower 102 at a temperature below which the catalyst in the reforming stage may be damaged but sufficiently high to heat the partial oxidation reforming catalyst 106 to a suitable temperature for initiation of the catalytic partial oxidation reaction.

By monitoring thermocouples 138, 139, 140, and 141, controller 142 determines when the reformer stage and downstream shift and selective oxidation stages have reached the second temperature regime. At this point, controller 142 closes valves 112, 136, and 190 such that only steam is passed via lines 124 and 154 to tower 102.

After a pre-determined time to purge the tower of oxygen, reforming is commenced. Fuel (e.g., methane) is introduced in line 134 and the pre-heated air/steam admixture is introduced via line 124, through heat exchanger 152 to the top of tower 102 by line 154. Partial oxidation reforming is conducted with a fuel-rich air/fuel mixture and is generally outside the flammability envelope. Thus, the reactants do not combust in burner 104. All of the oxygen is consumed by partial oxidation and combustion reactions in reformer stage 106 to provide heat for the steam reforming reaction. After partial oxidation light-off in stage 106, the heated reformate continues to provide heat for the downstream reactors and heat exchangers. Eventually, all of the downstream reactors will reach suitable operating temperatures and the start-up process is complete.

While the hydrogen generator has been described as having an indirect heat exchanger 114 with a first combustion and a second combustion occurring within tower 102 to provide the heat for start up, one may eliminate one of the combustions. For instance, combustor 104 may be eliminated so that all of the start-up heat is provided by combustor/heat exchanger 114. In this case, the pre-heated air/steam admixture in line 124 is the sole heat carrier for pre-heating tower 102.

One of the advantages of the use of a separate heat exchanger 114 is that the combustion effluent from the heat exchanger exhausted via line 158 can be used to heat a selective oxidation reactor to a temperature where the sought catalytic reaction will be initiated. As shown in FIG. 1, the exhaust from heat exchanger 114 can be passed via line 158 to selective oxidation reactor 168. Selective oxidation reactor 168 incorporates an indirect heat exchanger for recovering heat from the combustion effluent in line 158. The exhaust exits the apparatus via line 164. Gases exiting the bottom of tower 102 (via line 166) are cooled in heat-recovery exchanger 174 before passing to selective oxidizer 168.

A second advantage is that if the hydrogen from the apparatus is used for a fuel cell, waste anode gas from the fuel cell still contains hydrogen. The heating value of this hydrogen can be recovered by combustion and heat exchange in heat exchanger 114 with the incoming air and water. As the temperature of the air feed is increased, the portion of the fuel that must be combusted to maintain reforming temperatures is decreased, thereby increasing efficiency.

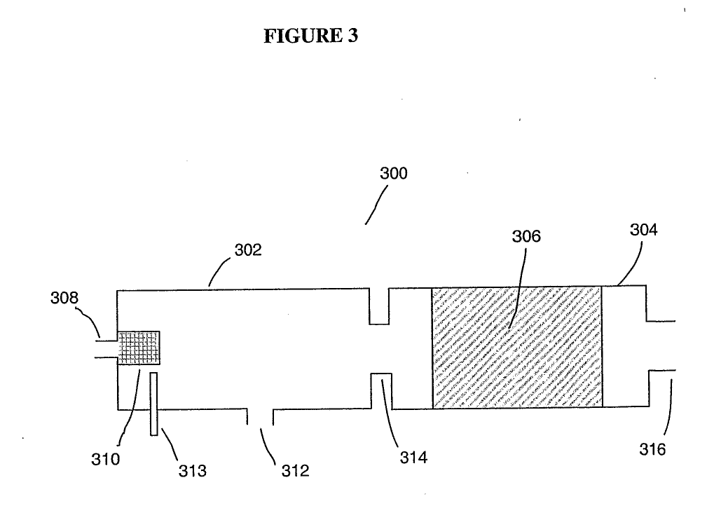

FIG. 3 illustrates a dual-mode combustor useful for combustion in a start up where fuel such as methane is consumed, and for combustion of anode waste gas comprising hydrogen. With reference to FIG. 3, combustor 300 comprises two chambers: a flame combustion chamber 302 and a downstream catalytic chamber 304 containing oxidation catalyst 306. The fuel, e.g., hydrogen or hydrocarbon, is introduced into inlet chamber 302 via port 308. In flame mode, an oxygen-containing gas is admixed with fuel in port 308. Port 308 is in communication with flame holder 310 inside chamber 302. The flame holder may be a screen or porous structure constructed of a temperature resistant material. It may or may not be catalytic. An igniter 313 provides heat to ignite the combustible mixture flowing through flame holder 310. Additional oxygen-containing gas is introduced via line 312 into the region of inlet chamber 302 surrounding flame holder 310. This gas serves to cool combustion product at the flame holder. The gases in inlet chamber 302 are passed via line 314 to catalytic chamber 304.

In catalytic mode, e.g., when combusting hydrogen-containing anode waste gas, igniter 313 is turned off and only fuel (anode waste gas) is provided in port 308. Oxygen-containing gas is added in port 312 and the catalytic combustion occurs in chamber 304 containing oxidation catalyst 306. The combustion effluent exits in line 316.

Returning to FIG. 1, once the hydrogen generation commences, the reformate from reforming stage 106 is cooled to temperatures suitable for a water gas shift reaction. While only one water gas shift stage is depicted, it is typical to use two or more stages with the subsequent stages operating at a lower temperature. Water is added to the reformate to reduce the temperature and to enhance the equilibrium toward the reduction of carbon monoxide. As shown, water from line 148 is passed to valve 170 and distributor 172 for introduction into the reformate. This mixture is contacted with catalyst in water-gas shift stage 108. The effluent from shift stage 108 passes from tower 102 via line 166 to heat exchanger 174 where it is cooled to temperatures suitable for selective oxidation. The cooled gases are then passed to selective oxidizer 168. Oxygen for the selective oxidation is provided via line 176 having control valve 178. Product hydrogen is provided via line 180 from selective oxidizer 168.

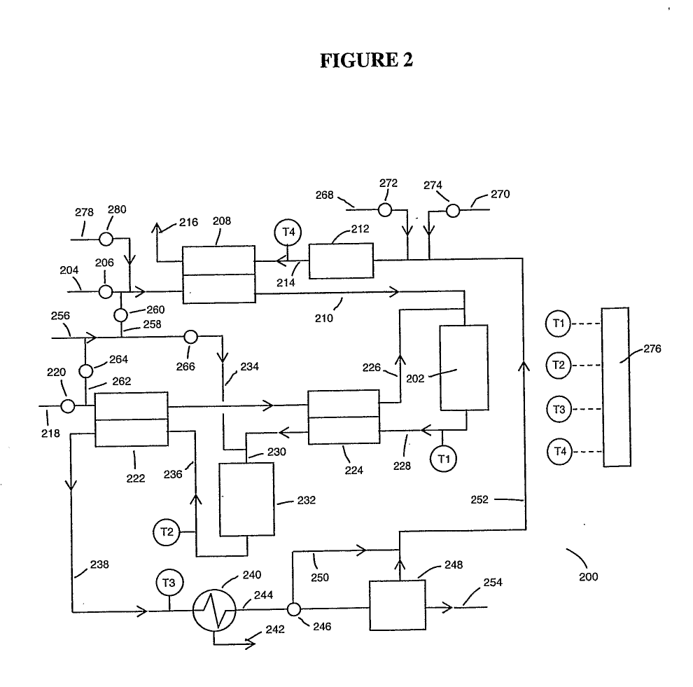

FIG. 2 depicts another embodiment of the apparatus of the invention. Hydrogen generator 200 comprises autothermal reformer 202. Oxygen-containing gas, e.g. air, is supplied via line 204 having valve 206, and is directed to a first side of indirect heat exchanger 208. Effluent from the first side of heat exchanger 208 is passed via line 210 to reformer 202. The second side of heat exchanger 208 receives a combustion effluent from combustor 212 via line 214. Line 216 exhausts the combustion effluent from heat exchanger 208.

Fuel, e.g., natural gas, for reformer 202 is provided by line 218 having valve 220. The fuel passes through the first side of two indirect heat exchangers, shift effluent exchanger 222 and then reformer effluent exchanger 224, and from there via line 226 to reformer 202.

The reformate from reformer 202 passes via line 228 to the second side of reformer effluent exchanger 224 where it is cooled and the incoming fuel to the reformer is heated. The cooled reformate exits via line 230 where it is passed to water gas shift reactor 232. The cooled gases are also admixed with additional water via line 234 which will be further discussed below. Shift effluent exits shift reactor 232 via line 236 and is directed to the second side of shift exchanger 222. The shift effluent is cooled while the fuel is heated in shift exchanger 222. The cooled shift effluent is passed via line 238 from shift exchanger 222 to cooler 240. Cooler 240 may be an air cooler or an indirect heat exchanger with water as the coolant. Due to the drop in temperature, water condenses and is removed via line 242 from cooler 240. The gases exit cooler 240 via line 244, which contains valve 246. Valve 246 either directs the gases to pressure swing adsorption unit 248 or causes the gases to bypass the adsorption unit. When bypassed, the gases are directed via line 250 to line 252, which is in fluid communication with combustor 212. Adsorption unit 248 provides a hydrogen product stream via line 254 and a waste gas stream which is passed via line 252 to combustor 212.

Water is provided to hydrogen generator 200 via line 256. This water can go via line 258 to line 204 supplying air. The amount of water passing through line 258 is regulated by valve 260. The water can pass via line 262 to line 218, which provides fuel to reformer 202. Valve 264 controls the rate of flow of water in line 262. Line 234, which provides water to the reformate for enhancing the water gas shift, is provided with valve 266 to control flow.

Nitrogen is available as an inert gas for the hydrogen generator. Nitrogen is supplied by line 278 having valve 280.

Combustor 212 is in communication with a source of oxygen-containing gas, e.g., air, per line 268 and a source of fuel per line 270. Line 268 is provided with valve 272 and line 270 is provided with valve 274.

Also, as shown in FIG. 2 is controller 276 which is in communication with temperature sensor T1 located downstream of reformer 202, temperature sensor T2 located at the outlet of shift reactor 232, temperature sensor T3 located in line 238 at the outlet of heat exchanger 222, and temperature sensor T4 located downstream of combustor 212.

By way of illustration of a start up procedure for the hydrogen generator of FIG. 2, the generator stands in a shut down mode under nitrogen purge. Valve 280 is closed and air is started to be passed via line 204 in an amount set by valve 206 to the cold side of heat exchanger 208 and then through line 210 to reformer 202 and then through reformer effluent exchanger 224, shift reactor 232, shift exchanger 222 and cooler 240. The effluent from cooler 240 is diverted by valve 246 to avoid passing through adsorption unit 248. This effluent is recycled to combustor 212 via line 252.

Fuel is supplied to combustor 212 via line 270, and additional air is supplied via line 268. The combustion gases are passed through the hot side of heat exchanger 208 and exhausted via line 216. The temperature of the combustion effluent is monitored by temperature sensor T4, and the introduction of fuel via line 270 is adjusted by valve 274. The introduction of air via line 268 is adjusted by valve 272 such that the temperature of the combustion gases are within a suitable temperature range.

Once controller 276 detects that the temperature of the gases at the outlet of heat exchanger 222 is within the first temperature regime, water is admixed with the air in line 204 via line 258. The water is vaporized and the air/steam mixture is brought up to a desired temperature in heat exchanger 208. The amount of fuel for combustion in combustor 212 is appropriately increased if necessary.

When temperature sensors T1 and T2 indicate that the generator has reached the second temperature regime, valve 206 is closed, and steam flows into the reaction system to purge oxygen. Upon completion of the steam purge, valves 206 and 220 are opened to permit air and fuel to enter the system to commence reforming to produce a hydrogen-containing reformate. Valves 264, 266 and 260 are adjusted to provide water in appropriate amounts for the reforming and shift reactions. Once the reformats begins to displace steam in cooler 240, valve 246 directs the hydrogen-containing gas to adsorption unit 248 to produce a hydrogen product gas. The pressure swing adsorption unit may be of any suitable design including rotary and multiple bed designs. The purging of the bed may be by vacuum, but most conveniently for simplicity, the purge is above ambient atmospheric pressure. A preferred system for low maintenance operation and high hydrogen recovery uses at least four fixed beds. By sequencing the beds through adsorption, regeneration, and pressure equalization steps, a continuous flow of purified hydrogen stream can be achieved without undue loss of hydrogen.

The adsorption unit generates a waste gas stream, which contains hydrogen as well as the removed impurities (e.g., nitrogen, carbon dioxide, carbon monoxide, and water). The waste gas stream is transported via line 252 to combustor 212. The amount of air and supplemental fuel added to line 252 are adjusted by valves 272 and 274, respectively, to control the combustion effluent temperature (measured by T4) and to provide heat to heat exchanger 208 to provide the desired preheating of the air and steam to be used for the partial oxidation reforming.

Hydrogen product purity from adsorption unit 248 is generally greater than 95 mol % and is often greater than 99.9 mol % or sometimes 99.99 mol %, depending on the application of the product hydrogen. Hydrogen recovery from the adsorption unit is generally greater than 60%, and often greater than 70% or 75%.

What is claimed is:

1. A process for starting up a hydrogen generator, which generator comprises a partial oxidation reformer containing partial oxidation and steam reforming catalyst adapted to provide a hydrogen-containing reformate and at least one downstream unit operation adapted to treat the reformate, comprising:
a. passing heated oxygen-containing gas sequentially through the partial oxidation reformer and at least one downstream unit operation to heat the partial oxidation reformer and at least one downstream unit operation to a first temperature regime, said first temperature regime a temperature in each of the partial oxidation reformer and the at least one downstream unit operation above that at which water condenses from a steam-containing gas of step (b) therein, wherein the temperature of the heated oxygen-containing gas is sufficient to effect such heating but below that which can unduly deleteriously affect catalyst in the partial oxidation reformer,
b. then passing heated steam-containing gas sequentially through the partial oxidation reformer and the at least one downstream unit operation until a second temperature regime is achieved, said second temperature regime being hotter than the first temperature regime and comprising a temperature in the partial oxidation reformer sufficient to initiate partial oxidation reforming and a temperature in the at least one downstream unit operation sufficient to initiate the intended unit operation, said steam-containing gas comprising at least about 10 volume percent steam and having a temperature sufficient to effect such heating but below that which can unduly deleteriously affect catalyst in the partial oxidation reformer, and
c. thereafter passing a fuel, oxygen-containing gas and water to the reformer whereby initiation of the partial oxidation reforming occurs and initiation of the unit operation in the at least one downstream unit operation is initiated, wherein the amounts of the fuel, oxygen-containing gas and water passed to the reformer are suitable for reforming.

2. The process of claim 1 wherein the temperature of the heated oxygen-containing gas in step (a) is between about 400° C. and 650° C.

3. The process of claim 1 wherein the at least one downstream unit operation comprises a catalytic reactor.

4. The process of claim 3 wherein for the first temperature regime the temperature of effluent from the partial oxidation reformer is below about 250° C.

5. The process of claim 1 wherein the second temperature regime comprises a temperature of effluent from the partial oxidation reformer of at least about 250° C.

6. The process of claim 1 wherein the temperature of the heated steam-containing gas is between about 400° C. and 700° C.

7. The process of claim 1 wherein the at least one downstream unit operation comprises a shift reactor and the second temperature regime comprises a temperature of effluent from the shift reactor of at least about 100° C.

8. The process of claim 1 wherein the steam-containing gas comprises oxygen-containing gas and prior to step (c) the partial oxidation reformer and the at least one downstream unit operation is purged with steam having an essential absence of free oxygen.

9. The process of claim 1 wherein the heated steam containing gas of step (b) comprises combustion gas.

10. The process of claim 1 wherein the oxygen-containing gas of step (a) comprises air.

11. A process for starting up a hydrogen generator, which generator comprises a partial oxidation reformer containing partial oxidation and steam reforming catalyst adapted to provide a hydrogen-containing reformate and at least one downstream unit operation adapted to treat the reformate, comprising:
a. heating oxygen-containing gas by indirect heat exchange in an indirect heat exchanger, said oxygen-containing gas being at a pressure above ambient pressure;
b. passing said heated oxygen-containing gas sequentially through the partial oxidation reformer and at least one downstream unit operation to heat the partial oxidation reformer and at least one downstream unit operation to a first temperature regime, said first temperature regime a temperature in each of the partial oxidation reformer and the at least one downstream unit operation above that at which water condenses from a steam-containing gas of step (c) therein, wherein the temperature of the heated oxygen-containing gas is sufficient to effect such heating but below that which can unduly deleteriously affect catalyst in the partial oxidation reformer,
c. then generating a heated steam-containing gas by introducing and vaporizing liquid water in the indirect heat exchanger and passing said heated steam-containing gas sequentially through the partial oxidation reformer and the at least one downstream unit operation to the partial oxidation reformer and the at least one downstream unit operation until a second temperature regime is achieved which is hotter than the first temperature regime, said second temperature regime being a temperature in the partial oxidation reformer sufficient to initiate partial oxidation reforming and a temperature in the at least one downstream unit operation sufficient to initiate the intended unit operation, said steam-containing gas having a temperature sufficient to effect such heating but below that which can unduly deleteriously affect catalyst in the partial oxidation reformer, and
d. thereafter passing a fuel, oxygen-containing gas and water to the reformer whereby initiation of the partial oxidation reforming occurs and initiation of the unit operation in the at least one downstream unit operation is initiated, wherein the amounts of the fuel, oxygen-containing gas and water passed to the reformer are suitable for reforming.

12. The process of claim 11 wherein the indirect heat exchanger is heated by combustion gas from the combustion of fuel.

13. The process of claim 12 wherein the combustion gas is subsequently used to supply heat to a downstream unit.

14. The process of claim 11 wherein the temperature of the heated oxygen-containing gas in step (a) is between about 400° C. and 650° C.

15. The process of claim 14 wherein the at least one downstream unit operation comprises a reactor and for the first temperature regime effluent from the partial oxidation reformer is less than about 250° C.

16. The process of claim 15 wherein the temperature of the heated steam-containing gas is between about 400° C. and 700° C.

17. The process of claim 16 wherein the at least one downstream unit operation comprises a shift reactor and the second temperature regime comprises a temperature of effluent from the shift reactor of at least about 100° C.

18. The process of claim 11 wherein the steam-containing gas comprises oxygen-containing gas and prior to step (d) the partial oxidation reformer and the at least one downstream unit operation is purged with steam having an essential absence of free oxygen.

19. The process of claim 11 wherein the heated steam containing gas of step (c) has a substantial absence of oxygen-containing gas.

20. The process of claim 11 wherein the oxygen-containing gas of step (a) comprises air.

21. A hydrogen generator comprising:
a. a partial oxidation reformer containing partial oxidation and steam reforming catalyst and having an inlet and an outlet,
b. at least one downstream unit operation having an inlet and an outlet wherein the inlet is in fluid communication with the outlet of the partial oxidation reformer,
c. an oxygen-containing gas supply line in fluid communication with the inlet of the reformer, said oxygen-containing gas supply line having a valve capable of shutting off the flow of oxygen-containing gas,
d. a combustor being in fluid communication with a fuel supply line,
e. a heat exchanger having a hot and cold side with the hot side in fluid communication with the combustor and the cold side in fluid communication with the oxygen-containing gas supply line,
f. a liquid water supply line in fluid communication with the oxygen-containing gas supply line and heat exchanger, said water supply line having a valve capable of shutting off the flow of water,
g. a fuel supply line in fluid communication with the inlet of the reformer, said fuel supply line having a valve capable of shutting off the flow of fuel,
h. at least one temperature sensor adapted to detect temperature between the inlet of the partial oxidation reformer and the outlet of the at least one downstream unit operation, and
i. a controller in communication with at least one of said temperature sensors, said controller being adapted to open or close the valve for the oxygen-containing gas supply line in response to a temperature detected by at least one of said temperature sensors, to open or close the valve for the water supply line in response to a temperature detected by at least one of said temperature sensors, and to open or close the valve for the fuel supply line in response to a temperature detected by at least one of said temperature sensors.

22. A process for starting up a hydrogen generator, which generator comprises a partial oxidation reformer containing partial oxidation and steam reforming catalyst adapted to provide a hydrogen-containing reformate, at least one downstream unit operation adapted to treat the reformate, and a catalytic combustor positioned between the partial oxidation reformer and a downstream unit operation comprising:
a. passing heated oxygen-containing gas sequentially through the partial oxidation reformer and at least one downstream unit operation to heat the partial oxidation reformer and at least one downstream unit operation to a first temperature regime, said first temperature regime comprising temperatures in each of the partial oxidation reformer and the at least one downstream unit operation above that at which water condenses from a steam-containing gas of step (b) therein, wherein the temperature of the heated oxygen-containing stream is sufficient to effect such heating but below that which can unduly deleteriously affect catalyst in the partial oxidation reformer,
b. then passing heated steam-containing gas sequentially through the partial oxidation reformer and the at least one downstream unit operation until a second temperature regime is achieved which is hotter than the first temperature regime, said second temperature regime comprising a temperature in the partial oxidation reformer sufficient to initiate partial oxidation reforming, said steam-containing gas having a temperature sufficient to effect such heating but below that which can unduly deleteriously affect catalyst in the partial oxidation reformer,
c. thereafter passing a fuel, oxygen-containing gas and water to the reformer whereby initiation of the partial oxidation reforming occurs and initiation of the unit operation in the at least one downstream unit operation occurs, wherein the amounts of the fuel, oxygen-containing gas and water passed to the reformer are suitable for reforming and a hydrogen-containing reformate is produced, and
d. injecting oxygen-containing gas into the catalytic combustor whereby hydrogen in the reformate is combusted, said injection being for a time sufficient to heat the downstream unit operation to a temperature sufficient to initiate the intended unit operation.

23. The process of claim 22 wherein the downstream unit operation downstream of the catalytic combustor comprises a water gas shift.

24. The process of claim 22 wherein the downstream unit operation downstream of the catalytic combustor comprises a heat exchanger.

25. The process of claim 22 wherein the downstream unit operation downstream of the catalytic combustor comprises a selective oxidation.

26. A process for the removal of thiophenes from a fluid containing at least one thiophene and at least one other organosulfur compound comprising contacting the fluid with a solid sorbent selective for thiophene sorption as compared to at least one other organosulfur compound to sorb thiophenes while allowing the at least one other organosulfur compound to break through.
